(19) United States
(12) Patent Application Publication
(10) Pub. No.: US 2018/0189583 A1
(43) Pub. Date: Jul. 5, 2018

(54) TRUSTED MOBILE BIOMETRIC ENROLLMENT

(71) Applicant: MorphoTrust USA, LLC, Billerica, MA (US)

(72) Inventors: Jay Wohlken, Brentwood, TN (US); Matt Baldree, Franklin, TN (US); Bradley G. Kaiser, Nashville, TN (US); Greg Willis, Billerica, MA (US); Greg Stegall, Billerica, MA (US)

(21) Appl. No.: 15/858,888

(22) Filed: Dec. 29, 2017

Related U.S. Application Data
(60) Provisional application No. 62/440,027, filed on Dec. 29, 2016.

(51) Int. Cl. G06K 9/00; G06F 21/32; G06K 9/62

(52) U.S. Cl. CPC G06K 9/00892; G06F 21/32; G06K 9/6201; G06K 9/00013; G06K 9/00604; G06K 9/00288

(57) ABSTRACT

A computer-implemented method is described and includes receiving, by a computing device, identifying data about a user, the identifying data including a digital self-image of the user, and extracting, by the computing device, one or more biometric identifiers about the user. The method further includes, verifying, by the computing device, at least one biometric identifier at least against a database that contains information about a plurality of individuals, and receiving, by the computing device, a confirmatory indicator associated with the user. In response to receiving the confirmatory indicator, the method still further includes, processing a pre-enrollment request associated with the user, the pre-enrollment request being associated with an identity verification program.

### TECHNICAL FIELD

The following disclosure relates generally to enrolling and verifying users.

### BACKGROUND

Some systems authenticate users at enrollment using biometric information. For example, state motor vehicle departments may obtain facial images and fingerprints of drivers at the time of providing driver's licenses. Some systems verify enrolled users using biometric information. For example, a driver may have to provide facial images and fingerprints when he or she attempts to renew her driver's license. Moreover, user enrollment into one or more identity verification and management programs can require onsite and in-person visits from prospective enrollees.

### SUMMARY

This specification describes mobile systems and processes to enable a computing device, such as a smartphone or related mobile device, to collect and transmit data in a secure or trusted manner to facilitate biometric-based user enrollment into one or more programs. The specification describes processes that include collecting data concurrently from multiple biometric capture devices in a one-to-many (1:M) relationship. The programs can include a variety of state, federal, and commercially managed identity verification programs. The programs generally can require secure, standards-based identity proofing and 3^{rd}-party or direct identity credentialing to successfully accomplish user enrollment.

The subject matter described in this specification can be implemented in particular embodiments and can result in one or more of the following advantages. The systems and processes of this specification gives customers a more convenient, near self-service enrollment experience that remains compliant with relevant security frameworks and will accommodate rapid surges in enrollment demand by leveraging customer or company-owned mobile devices during the enrollment process. Implementation of the systems and processes described herein will create customer value and will provide benefits including: 1) increased enrollment volume and associated revenue; 2) decreased cost per enrollment; 3) increased partnership location utilization and flexibility; 4) greater workstation mobility and density; 5) expanded hours of accessibility for customers; 5) increased biometric collection and data security during collection process; 6) enhanced customer satisfaction.

This specification describes systems and processes that include use of a mobile computing device by a user to submit identity data during a pre-enrollment phase of an identity enrollment program and to submit related identity data by the same user during a corresponding on-site enrollment phase of the identity enrollment program. In particular, this specification describes, for example, one to many (1:M) biometric collection processes whereby multiple devices can concurrently transmit data to a single mobile device or tablet. Described novel approaches also include, use of systems to connect or associate identity data received for a user during the pre-enrollment phase with identity data received for the same user that performs collection of biometrics during the on-site enrollment phase.

In general, secure transmission of data provides systems with high trust characteristics that implement standards-based protocols to, in part, verify the integrity of user submitted identity data. For example, backend users/computing systems that process identity program enrollment submissions can trust that the received user identity data has been verified as accurate and corresponds to the actual applicant accomplishing the submission. In some implementations, source-of-records (SOR) checks can be performed to reduce risks associated with receipt of fraudulent identity data and also to customize treatment of the enrollment application.

Moreover, on-site enrollment processes are described that include self-service or lightly attended processing which supports speedy collection of applicant biometrics for submission to backend systems that process enrollment applications. Biometric devices disposed at on-site enrollment facilities can be configured to collect and store applicant feedback. Collection of applicant feedback during the on-site enrollment process enables bio-capture stations at these facilities to support streamlined self-collection of biometrics. Additional processes implemented during the on-site enrollment phase can include real-time monitoring capabilities implemented via a mobile computing device managed by an on-site enrollment agent (EA) that monitors the collection of biometric data for multiple customers. Other processes include virtualization of biometric collection capabilities implemented, at least in part, by the elimination of hardware peripherals associated with current biometric capture workstations.

One aspect of the subject matter described in this specification can be embodied in a computer-implemented method. The method includes, receiving, by a computing device, identifying data about a user, the identifying data including a digital self-image of the user; extracting, by the computing device, one or more biometric identifiers about the user; verifying, by the computing device, at least one biometric identifier at least against a database that contains information about a plurality of individuals; receiving, by the computing device, a confirmatory indicator associated with the user; and in response to receiving the confirmatory indicator, processing a pre-enrollment request associated with the user, the pre-enrollment request being associated with an identity verification program.

These and other implementations can each optionally include one or more of the following features. For example, in some implementations, method further includes: executing, by the computing device, a facial recognition program to determine whether the digital self-image of the user matches a digital image of the user that is associated with an identification document. In some implementations, receiving identifying data about the user includes at least one of: scanning, via the computing device, one or more identification documents associated with the user; receiving, by the computing device, manually entered identity data about the user; or capturing, by the computing device, the digital self-image of the user.

In some implementations, the method further includes: receiving a biometric data associated with the user, wherein receiving the biometric data includes at least one of performing a scan of an eye of the user or performing a scan of a fingerprint of the user. In some implementations, the confirmatory indicator includes the user's signature and provides confirmation that the user consents to one or more legal terms associated the identity verification program. In some implementations, the method further includes: verifying, by the computing device, the user's eligibility to enroll in a pre-enrollment phase of the identity verification program, wherein verifying the user's eligibility includes analyzing a phone number associated with the user.

Another aspect of the subject matter described in this specification can be embodied in a method that includes, verifying at least one identity attribute of a user, based at least in part on a visual inspection of an identification item associated with the user; receiving, by a computing system, identifying data about one or more users, the identifying data including at least one of a digital self-image of the user and a first biometric attribute; and indicating, by the computing system, a quality metric associated with the received identifying data for the one or more users. The method further includes receiving, by the computing system, an authentication attribute that can be used to verify that the one or more users have the requisite permission to submit an identification record associated with an enrollment request for an identity verification program; verifying, by the computing system, the identification record against a database that contains information about a plurality of individuals; and processing, by the computing device, an on-site enrollment request associated with the user for enrollment into the identity verification program.

These and other implementations can each optionally include one or more of the following features. For example, in some implementations, receiving identifying data about the one or more users includes receiving the identifying data and concurrently transmitting the identifying data from one or more biometric capture devices to a mobile device associated with the computing system. In some implementations, identifying data received about respective one or more users corresponds to identifying data received at an earlier time-period about the same respective one or more users. In some implementations, identifying data received about the respective one or more users corresponds to on-site enrollment data, and the identifying data received at the earlier time-period about the same respective one or more users corresponds to pre-enrollment data.

Implementations of techniques described in this specification include methods, systems, computer program products and computer-readable media. One such computer program product is suitably embodied in a non-transitory machine-readable medium that stores instructions executable by one or more processors. The instructions are configured to cause the one or more processors to perform one or more actions described in this specification. One such computer-readable medium stores instructions that, when executed by a processor, are configured to cause the processor to perform one or more of the actions described herein. One such system includes one or more processors and a storage device storing instructions that, when executed by the one or more processors, cause the one or more processors to perform the actions described herein.

The details of one or more disclosed implementations are set forth in the accompanying drawings and the description below. Other features, aspects, and advantages will become apparent from the description, the drawings and the claims.

### BRIEF DESCRIPTION OF THE DRAWINGS

FIG. 1 illustrates an example system for acquiring user information during a pre-enrollment process of a program.

FIG. 2 illustrates an example system for acquiring user information during an on-site enrollment process of a program.

FIGS. 3A, 3B, and 3C depict diagrams that are associated with processes that can be executed by the system of FIG. 1 or the system of FIG. 2 to acquire one or more biometric identifiers.

FIG. 4 illustrates an example process for acquiring user information during a pre-enrollment phase of a program.

FIG. 5 illustrates an example process for acquiring user information during an on-site enrollment.

### DETAILED DESCRIPTION

Systems that provide biometric recognition and/or verification for verifying particular characteristics of an individual, such as an individual's identity, age, ethnicity, criminal history, or some other suitable characteristic, are based on system users undergoing enrollment in the system. During an enrollment procedure, a user typically presents information verifying the user's identity, such as documents that attest to her true identity, and scans of one or more biometric identifiers. Once a user is enrolled into the system, biometric information about the user may be presented in subsequent transactions to recognize or verify the user and to indicate to the system that this user has undergone enrollment.

In this context, biometric identifiers, include distinctive, measurable characteristics of a person that may be used to uniquely label and/or describe the individual. Biometric identifiers may be categorized as particular physiological characteristics related to the individual's body. Examples of biometric identifiers include, but are not limited to, fingerprint, palm veins, face recognition, DNA, palm print, iris recognition, and retina patterns, among others.

Current methods of enrolling users in biometric systems are dependent on users initiating enrollment into the system by providing one or more pieces of identifying information. As designed and implemented, enrollment may be an involved process that may require a new user to fill out forms, take photos, scan fingerprints, etc. The enrollment procedure may be of a prolonged duration and have a negative impact on the user's experience. It may be useful to implement techniques that reduce the time expended in an enrollment procedure and thereby improve the user experience. Such techniques may incorporate a pre-enrollment phase and an on-site enrollment phase which combine to form the full enrollment process.

This specification describes systems and processes that provide customers/users with a convenient and secure identity verification program enrollment experience that is able to support a high volume of applicants. Implementation of the systems and processes described herein allow enrollment program applicants (e.g., customers/users) to use personal mobile devices to collect and submit biometric-based enrollment data without compromising data security or related federal privacy standards.

The described subject matter encompasses one or more methods that enable customers to submit personal information, biographic data, digital self-images (e.g., selfies), legal documents, payment information, and signatures required for identity proofing services. The methods can be embodied and executed, at least in part, in an application such as executable program code configured for securely collecting and transmitting data via wireless, cellular, or satellite signal transmission from a mobile device such as a smart phone or tablet.

In some implementations, program enrollment processing systems can include an application tool for creating a temporary trusted permission token (or other trusted permission methods) to allow an applicant to acquire biometric data via wired or wireless signal transmission while located at an on-site enrollment center. The temporary trusted permission token can be a single-use token. Thus, through application of a time limited single-use token, the enrollment processing system can prevent unauthorized system use after a specific window of time has elapsed. This token ensures that the biometrics collected belong to, and can be associated with, the correct applicant and pre-enrollment data. This capability is required in the 1:M configuration of the tablet to multiple biometric capture devices.

Further, the example enrollment processing system can integrate with an example biometric capture station and enable secure collection of biometric data such as fingerprints, 10-print fingerprints, face image acquisition, and iris feature acquisition. The collected biometric data can be securely acquired and loaded onto a user's mobile device for secure transmission to a remote database for further processing. Moreover, the enrollment processing system can also integrate with one or more back-end/remote computing assets to perform user document authorization against source-of-truth databases and to perform mobile device reputation/verification checks. In some implementations, collection and wired or wireless transmission of biometric data is performed in accordance with minimum-security standards for application into federal programs.

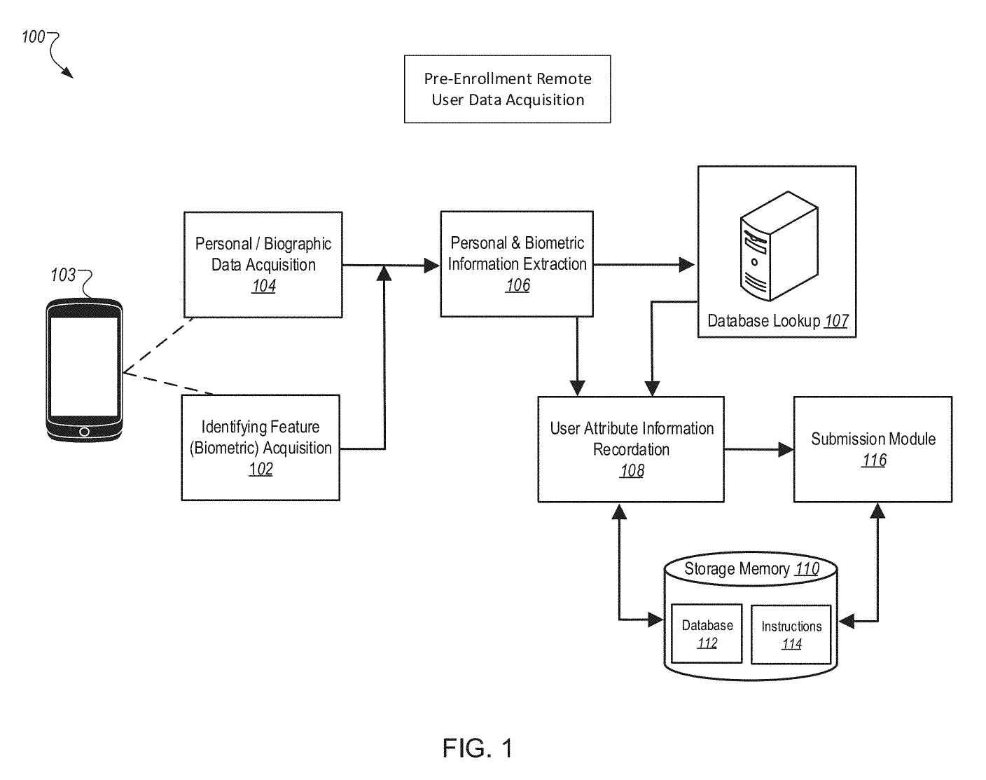

FIG. 1 illustrates an example system 100 for acquiring user information during a pre-enrollment process of an example identity enrollment program. System 100 generally includes a user device 103, a first data acquisition module 102, a second data acquisition module 104, and an information extraction module 106. System 100 further includes a database lookup module 107, an information recordation module 108, a storage memory 110, and a submission module. Storage memory 110 generally includes a database 112 and instructions 114. Example user devices 103 include smartphones, mobile devices, laptop/desktop computers, smart televisions, tablet computing devices or another related computing device.

In general, system 100 can be implemented, in part, by execution of program code in the form of an executable application, otherwise known as an “app,” that can be launched or executed from user device 103. Upon execution of the application program code, the app can then establish a data connection with the one or more modules and storage memory of system 100. In some implementations, once launched from an example user device 103, the app associated with system 100 can be granted certain permissions by users of device 103. The permissions can cause system 100 to, for example, have access to data associated with one or more other application programs or apps stored within a memory unit of user device 103.

In some implementations, the system 100 may be implemented, in part, in a hardware device that incorporates all the modules shown in FIG. 1. For example, system 100 can be include a computer with a scanner, camera, or other optical input; a processor; a storage device; and input/output such as a keyboard, a mouse and a display. Alternatively, system 100 can include a portable device (e.g., a smartphone) with a camera, a processor, on board memory, a touchscreen display that also provides input functionality, and/or additional input hardware (such as hardware buttons). In some implementations, system 100 can include separate hardware components that are coupled to one another. For example, system 100 can include a scanner, camera or other optical device, which is coupled to a computer with a processor, storage memory and a display. Other suitable configurations of system 100 are also possible.

First data acquisition module 102 can be a module adapted to acquire certain biometric or identifying features of a user. For example, module 102 can be a digital image acquisition or camera application configured to capture a digital self-image of the user. Second data acquisition module 104 can be a module adapted to acquire certain personal or biographic data relating to the user. For example, module 104 can be a digital document scanning application configured to scan or capture a digital image of a variety of documents or receive manual entry of personal information from a user.

In some implementations, module 102 is configured to obtain one or more biometric identifiers of users. For example, module 102 can be configured to obtain an iris scan or a fingerprint specific to a particular user. Module 102 may include an optical component to obtain the biometric identifier(s), such as scanner, camera, or other suitable hardware, to capture images of a user's facial or other physical features.

In some implementations, module 102 may obtain one or more biometric identifiers while an applicant utilizes system 100 to complete a pre-enrollment phase of an example identity verification program. In some implementations, module 102 and module 104 can each receive manually entered identifying information about users. For example, information about a user's name, date of birth, social security or driver's license number, gender, ethnicity, among others, can be manually entered into a pre-enrollment form by an applicant. In some implementations, modules 102, 104 may determine some of these demographic characteristics from other information that is manually entered.

As described in more detail below, obtaining demographic characteristics of a user from scanned documentation or manually entered user information can be performed by information extraction module 106. In some implementations, information acquired by module 102 is provided to a processor included in system 100 for generating a corresponding biometric identifier. For example, the processor may execute mathematical and programmed algorithmic routines to generate and store user facial feature data from a digital self-image, fingerprint data from an image of user's finger, or a digital template of a user's iris from an iris scan. User data including images and scanned documents acquired by modules 102, 104 and/or the resulting biometric identifiers that are generated, may be stored in the database 112. The stored data and images in database 112 may be used for processing pre-enrollment requests for an example identity verification program.

In general, modules 102, 104 and 106 cooperate to offer high fidelity biometric data capture services for wireless transmission of personal data for identity verification processing. For example, as shown in FIG. 1, an image or related personal data obtained by modules 102, 104 can be input to extraction module 106. Extraction module 106 processes scanned data documents and digital images to extract personal and biometric information about a user/applicant associated with the pre-enrollment process. In some implementations, extraction module 106 can be implemented as one or more software or firmware routines that are executed by a processor included in system 100.

Personal and biometric information extracted by module 106 is provided as input data to information recordation module 108, which can be implemented as one or more software or firmware routines that are executed by a processor included of system 100. In alternative implementations, personal and biometric data extracted by module 106 is provided as input to database lookup 107. Database lookup 107 can be a module configured to search verified identity records in an example database (not shown) to find related identity records that include personal and biometric identifiers corresponding to those acquired by modules 102, 104.

In general, database lookup 107 can be used to verify personal documents and digital self-images that an applicant scans and uploads to system 100. Database lookup 107 can use real-time lookup/search functions to perform user data verification against source-of-truth databases maintained by a variety of government and commercial entities. In some implementations, at least one of database lookup 107 or submission module 116 can be configured or programmed to perform facial recognition between a digital self-image uploaded by the applicant and a digital image of the applicant associated with documents such as passports and driver licenses. In some instances, database lookup 107 can perform applicant data verification and facial recognition between user captured self-images and document self-images and provide the results to recordation module 108 for transmission to submission module 116.

Recordation module 108 generates identity/identification records of users during an example pre-enrollment process executed by system 100. In one instance, recordation module 108 can populate fields in an identity record with personal or biometric data extracted by module 106. For example, recordation module 108 can populate one or more fields corresponding to a user's height, eye color, gender, ethnicity, hair color, age, or weight, based on the extracted information. In other instances, recordation module 108 also adds manually entered information to the identity record. For example, the user's name, date of birth, social security number, etc. may be manually entered and recordation module 108 may then populate the corresponding fields in the identity record with the manually entered information.

Identity records that are generated and populated by recordation module 108 can be stored in database 112. Recordation module 108 may also store, in database 112, the data and images obtained by modules 102, 104. In some implementations, database 112 may be implemented in storage memory 110, which can include read-only memory (ROM) and/or random access memory (RAM). Additionally, or alternatively, storage memory 110 can include flash memory, magnetic or optical memory, such as hard disk drives, computer disc or digital video disc memory (CD-ROM or DVD-ROM), among others.

In some implementations, storage memory 110 can also include instructions 114 that are executed by one or more processors associated with system 100. Instructions 114 may encode routines corresponding to one or more functions executed by at least one of module 102, module 104, extraction module 106, recordation module 108, or submission module 116.

Submission module 116 can be used to compare data acquired by extraction module 106 to data acquired by module 102. For example, submission module 116 can receive data corresponding to a user's gender, age, or ethnicity that were extracted by module 106 from acquired user data. Submission module 116 also may receive manually entered information about the user's gender, age, or ethnicity that are obtained by module 104. For each characteristic, submission module 116 can compare the manually entered data/information to data extracted by module 106 to ensure that the corresponding characteristics are consistent (e.g., match). If the manually entered characteristic does not match the extracted characteristic, then submission module 116 can generate an alert, e.g., to warn about potential errors in the extracted information or manually entered information.

In some implementations, submission module 116 can perform the comparison concurrently with populating the identity record by recordation module 108. For example, submission module 116 can check the manually entered data at the time of pre-enrollment and compare this data to the extracted data. If there is a discrepancy, then submission module 116 can provide a control signal to module 108 to cause the module to reject, for example, the manually entered information and generate an alert notifying the user.

In certain embodiments, system 100 can be designed to include one or more identity assurance and fraud prevention measures from a variety of measures. In some implementations, system 100 can be configured to perform a device reputation check on the mobile/computing device being used to complete pre-enrollment. For example, the application associated with system 100 may prompt the user to enter their mobile number (or an identification number associated with device 103). In response to receiving the mobile number, the application can perform a look up on the device used for pre-enrollment to ensure that the device is not stolen and the user and/or the user's geography matches related information submitted to system 100 for pre-enrollment. In some instances, system 100 can also be configured to compare billing address information associated with the mobile number to address information entered in the application associated with system 100.

In some implementations, system 100 can be designed or configured to perform a fraud check on personal information entered by the user. Fraud checks can be performed by, for example, checking the entered information against a death certificate database to ensure that the application is not being fraudulently submitted under the name of a deceased person. In some instances, system 100 can also perform verification checks on the address/residence information entered by the user. Verification checks on address information can be performed by, for example, initiating a look up on the entered address against an address database to ensure that the applicant's address entered in the application program matches the address on file in the address database.

System 100 can also be configured to implement source-of-record (SOR) verification checks in which the name and identifying information entered by or associated with the applicant is checked against an external SOR database. In general, the SOR verification checks can be implemented to guard against or preclude use of doctored documents and/or to potentially detect that certain documents required to complete pre-enrollment have not been submitted. In addition to SOR verification checks, system 100 can use one or more physical device authentication tools to verify identifying information about a user. In some implementations, system 100 can also be configured to perform a credit card, credit worthiness, or general financial check on the applicant submitting pre-enrollment information for entry into the identity verification program. In some instances, system 100 can use a card number of a credit/debit card submitted for payment as an additional means of verifying identity consistency throughout the enrollment process.

In another instance, system 100 can also be configured to generate a risk score in which the outputs/results of the aforementioned identity assurance and fraud prevention checks are used as inputs to a risk score algorithm that determines whether or not pre-enrollment self-capture is permitted or whether other levels of oversight should be implemented regarding overall enrollment processing.

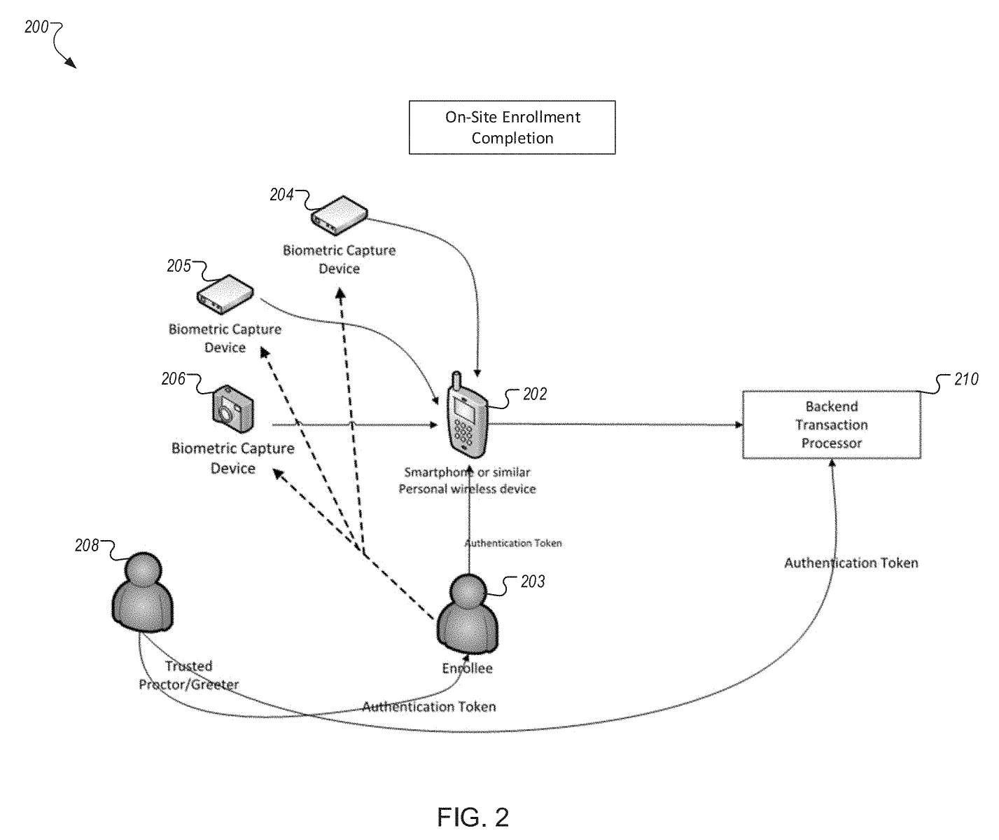

FIG. 2 illustrates an example computing system 200 for acquiring user information during an on-site enrollment process of an identity verification program. System 200 generally includes a computing device 202, user/enrollee 203, a first biometric capture device 204, a second biometric capture device 205, and a third biometric capture device 206. Although computing device 202 is depicted as a smartphone or similar personal wireless device, in alternative embodiments, computing device 202 can be a laptop computer, a desktop computer, tablet computer or any other related computing system or device.

In some implementations, capture device 204 can be an example iris scanner configured to scan a user or individual's eye to acquire and store digital representations of biometric data associated with characteristics of the user's eye(s). Similarly, capture device 205 can be an example fingerprint scanner configured to scan a user or individual's fingers to acquire and store digital representations of biometric data associated with the user's fingerprints. Moreover, capture device 206 can be an example digital camera configured to capture digital images or self-images of user 203. In alternative embodiments, at least one of capture device 204 or 205 can be configured to perform one or more other types of biometric acquisitions such as palm print biometric acquisition, voice pattern biometric acquisition, or skin texture biometric acquisition.

System 200 further includes proctor 208 and backend transaction processor 210. Processor 210 can be an example computing system configured to process application submissions from user(s) 203 for enrollment into an identity verification program. In some implementations, applications are processed in response to processor 210 receiving an authorization token. The authorization token can be used verify and/or indicate that user 203 has the requisite permission to submit an identity record associated with a program enrollment application. In some implementations, rather than distinct or separate biometric capture devices (e.g., devices 204, 205, 206) a single biometric capture device can be used. The single biometric capture device can be an integrated tablet computing device having peripheral functions/features, such as fingerprint scanning, eye/iris scanning, chipped credit card reading technology, TWIC/PIV, and passport radio frequency ID reading technology.

The integrated biometric device can include a form factor and tablet stand that are configured to optimize user interaction with the device such that the system can quickly capture enrollment data and minimize undue ergonomic stress that may be experienced by human agents. The device is configured with a power management control scheme that cycles power to peripherals at opportune moments, which allows for improved battery life and more effective control of power consumption from device peripherals. The security features of the integrated biometric capture device include physical features to lock the device, non-standard screw heads to reduce the likelihood of unexpected access, and tamper evident tape.

Further, the integrated biometric capture device includes a full suite of biometric capture functions (e.g., fingerprinting, iris scans, etc.) and is configured to encrypt received biometric data and securely transmit portfolios of biometric information. Moreover, the integrated biometric device includes an offline mode so that enrollment information can still be captured and processed even if network or internet connectivity is lost or temporarily disabled. The device also includes sufficient memory and disk space to support remote administration, updating, and processing.

Much like system 100, system 200 can also be implemented, in part, by execution of program code in the form of an executable application, otherwise known as an “app,” that can be launched or executed from device 202. Upon execution of the application program code, the app can then establish a data connection with the one or more biometric capture devices and processor 210 of system 200.

As shown in FIG. 2, proctor 208 can provide a single-use time delimited authorization token to user 203 as well as to processor 210. User 203 can then provide or enter the authorization token to an example application program executable from computing device 202. In some implementations, the authorization token allows an applicant to acquire biometric data via wired or wireless signal transmission while located at an on-site enrollment center. Accordingly, entering the authorization token into the application program enables/allows user 203 to use device 202 to capture or acquire biometric data from each of capture devices 204, 205, 206. Because the authorization token is single-use, temporary, and time-delimited, use of the token to complete enrollment processing within system 200 prevents unauthorized system use after a specific window of time has elapsed.

In alternative implementations, in addition to using an authorization token or pin to securely transfer information from the data/biometric capture devices 204, 205, 206, to processor 210, a radio frequency identification (RFID) chip associated with a trusted device could also be used to ensure user biometric and identity data are transferred from the trusted device; thereby increasing the overall trust level of the identity enrollment/registration process.

In some implementations, in addition to, or lieu of, the permission/authorization code, system 200 can include an RFID model in which the applicant “checks out” a trusted device, self-captures biometrics, and returns the trusted device to the EA to inspect and complete the enrollment submission. Use of the RFID model would ensure that user biometrics never inadvertently combined with another applicant's biometric data since the trusted device remains with the applicant for the duration of enrollment such that certain numbers will not be accidentally or intentionally mistyped.

The following process steps describe an example customer/user experience that reflects the process, technology, and combinations associated with example embodiments of system 100 and system 200. With regard to system 100, in some implementations, while at location that is convenient for the user (e.g., home, or other related environment), the user downloads an example pre-enrollment app onto a mobile device, such as a phone or tablet with cellular or satellite data connection. The user uses the app, or a related web application, to scan, upload and submit identifying data required for pre-enrollment into an example identity verification program.

In some implementations, the user can either scan or manually enter data associated with one or more identity documents. Example identity documents include items such as valid U.S. Passports, Driver's License, social security card, etc. In some instances, the application program extracts identifying information from the uploaded documents and pre-populates one or more data entry fields associated with an interface of the application program.

In addition to, or lieu of, data entered from the scanned identifying documents, the user can also enter personal information and/or biographic information or data. Examples of personal or biographic data include items such as name, address, military service, number of dependents, marital status, etc. After entry of the one or more data items, the user may be prompted by the application to “accept,” or “acknowledge” certain legal terms relating to various legal subject matter associated with privacy law, paperwork reduction acts, accuracy of statements/data entered or any other related legal or regulatory subject matter. In some implementations, a confirmatory indicator is triggered and received by one or more different devices of system to indicate that the user has accepted or acknowledge the legal terms.

The user can launch a camera application associated with the mobile device to capture a digital self-image that includes a digital representation of the user's face. The user/customer can further utilize the application to submit monetary payment to system 100 to complete submission of a pre-enrollment application and to initiate further processing.

In some instances, system 100 can be configured to execute program code for verifying identity documents and digital self-images using, for example, real-time lookups against source-of-truth databases. Moreover, system 100 can prompt or enable the user, through the application, to schedule an appointment to visit a physical enrollment center to complete additional biometric screening such as fingerprinting, etc. In response to scheduling the appointment through the application, the user can receive an electronic mail (e-mail) message or short message service (SMS) text notification with a receipt that includes a transaction identification number associated with the pre-enrollment request.

In some implementations, in advance of the appointment, the user/customer can receive an SMS text notification to remind the customer that he/she has an upcoming appointment at the physical enrollment center. In some instances, the user receives the SMS text notification 24 hours before the scheduled appointment time. While in other instances another time period or method can be used for providing a notification to the user in advance of the appointment. In general, the notification can include an address that can be clicked to launch an example navigation program, the date and time of the appointment, and a phone number for the enrollment center.

With regard to system 200, in some implementations, the user/customer visits the Enrollment Center (EC) or related fingerprinting/biometrics acquisition site. In one instance, the Enrollment Center is a Universal Enrollment Center (UEC) that processes multiple application submissions for a variety of different identity verification programs. After arriving at the EC/UEC the user provides an identity document, such as a driver's license or related identification (ID) card to an enrollment agent assigned to the UEC. The enrollment agent (EA) can visually scan the user's ID card to compare the user's name indicated by the ID card against an electronic or physical appointment list. In some implementations, the appointment list is populated in response to users submitting the pre-enrollment application through system 100.

Once user pre-enrollment is confirmed, the EA generates a temporary permission/authorization token and shares it with the user. The user can then enter the temporary permission/authorization token in the above application loaded to the user's mobile device. The temporary authorization token allows the personal/mobile cellular device to accept wireless biometric data from one or more capture devices (device 204, 205, 206) for a limited window of time (e.g., 10 minutes). In some implementations, the token will also associate the captured biometric data with the appropriate backend transaction/enrollment processing system. In some instances, the EA can direct the customer to a particular biometric capture device/station and monitor activities that occur at the capture device to ensure that no other individuals are allowed to substitute their own biometric attributes in lieu of the user's biometric attributes.

The example application loaded on the user's mobile device can include step-by-step instructions to guide the user through the on-site biometric data capture process. An example biometric data capture sequence can include the following process steps: 1) fingerprint thumbs and repeat thumb capture until a print quality is achieved that meets or exceeds a predefined threshold print quality (e.g. threshold print quality for federal identity programs such as TSA Pre✓®); 1a) fingerprint 4 fingers on right hand; fingerprint 4 fingers on left hand; 2) capture iris scan.

The application can be configured to securely submit, (manually or automatically) an enrollment request to a secure backend processing system (processor 210) over an encrypted service such as cellular or satellite service. In some implementations, captured biometric data can be wirelessly transmitted to an example computing device such as personally owned or company owned mobile device. The personal or company owned mobile device can then be used to complete follow-on process steps to complete submission of an enrollment request. Additionally, the application can be further configured to auto-delete any saved or cached personal or digital biometric data associated with the applicant as well as disallow or preclude further biometric data capture after submission of the enrollment application. In some instances, submission of the enrollment application includes relaying data from a secure backend processing system to a federal background check service provider.

The application can also include e-mail and SMS/text based notifications that are provided to customers along with a transaction identification number for status/tracking information and routine or periodic updates associated with the submitted enrollment application. The application can further include other capabilities, such as look-up status functions for submitted enrollment requests as well as storing information such as an applicant's known travel number (KTN). In some implementations, the application can include “contact us” function or a stadium fast pass access function.

In some implementations, the UEC can include one or multiple capture kiosks that can take one of several different forms. For example, the capture kiosk can be an applicant's mobile phone or tablet that includes cellular, satellite, or similar wireless service that interacts with the aforementioned example application. In another example, the capture kiosk can be a tablet device that is owned, configured and managed by MorphoTrust USA and that uses its own cellular, wired, or wireless signal transmission service to submit identity program enrollment applications. In some implementations, the tablet device can include a built-in iris scanning system as well as a mobile device holder.

The on-site (i.e., user located at UEC) enrollment process can include one of several variations. For example, an applicant may complete enrollment on their personal mobile device, on a tablet device, or on a related computer device such as a laptop or desktop computer. In instances where the user completes onsite enrollment via their mobile device, system 200 can configured to perform a mobile device verification check to ensure that the device being use to complete enrollment is recognized via a device reputation verification service.

As indicated above, in some instances an applicant may enroll on a MorphoTrust-owned computing device. In general, transfers of captured/acquired biometric data from the capturing devices 204, 205, 206 to mobile device 202 can be accomplished by, for example, plugging the device into a physical connection (tethered connection) rather than wirelessly. In some implementations, the biometric capture devices may take various physical forms and may or may not be physically attached to each other.

In one instance, one or more additional steps may be required for the Enrollment Agent to certify that the activities conducted by the user to complete enrollment were appropriately monitored and completed by the expected individual. Additionally, oversight and certification from the EA can help to ensure that any submitted personal, biographic, and biometric data belongs to the individual that performed the submission. The location of capture stations, an EC, or a UEC may take one of several forms. For example, enrollment centers and/or capture stations can be existing MorphoTrust USA Enrollment Centers; a MorphoTrust USA partner site, or a MorphoTrust USA rapid response mobile site.

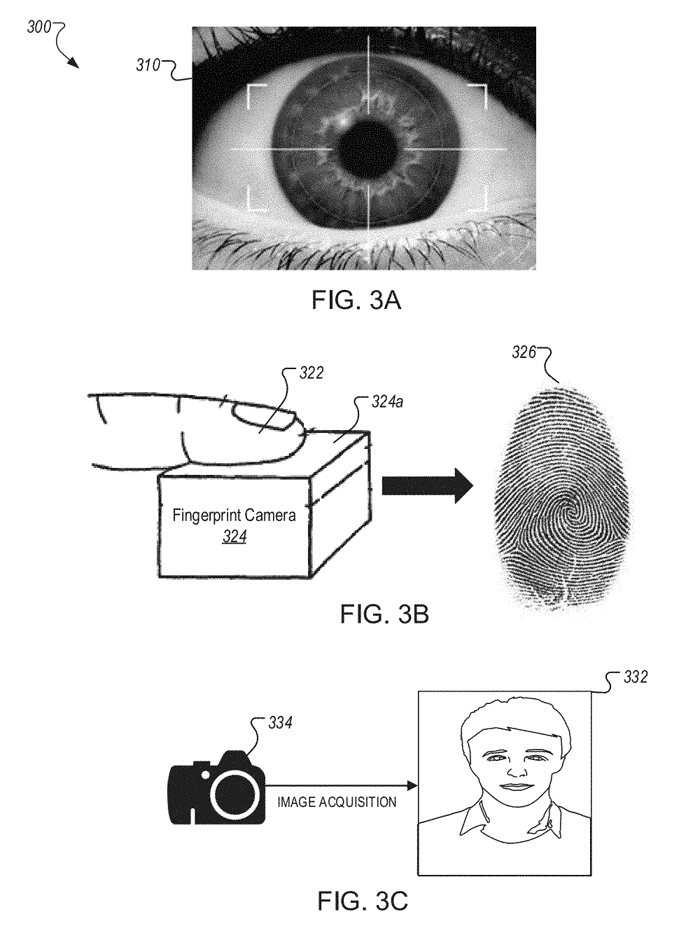

FIGS. 3A, 3B, and 3C depict diagrams 300 that are associated with example processes that can be executed by system 100 of FIG. 1 and a system 200 of FIG. 2 to acquire one or more biometric identifiers. In some implementations, one or more biometric identifiers of an applicant can be obtained or acquired during pre-enrollment or on-site enrollment into an identity verification program. For example, a biometric identifier that is used for enrollment may be the user's iris. FIG. 3A shows an example 310 of scanning the user's iris during the enrollment process. The iris scan 310 may be performed using a suitable optical device, e.g., a camera that can scan and capture an image of the iris.

As another example, a biometric identifier that can be used for enrollment may be the user's fingerprint(s). FIG. 3B shows an example of capturing a print of the user's finger 322 using a fingerprint camera 324 during the enrollment process. The fingerprint camera 324 scans the user's finger 322 that is placed on a plate 324a of the camera, and records a fingerprint 326 corresponding to the finger 322. In some implementations, captured or recorded fingerprints can take different forms (e.g., ten-print, 1 finger, 2 finger, or rolls) and can differ in characteristics (FAP 45 vs. FAP 60) and quality (NFIQ 1 vs. NFIQ 6). As used herein, FAP corresponds to Fingerprint Acquisition Profile, NFIQ corresponds to NIST Fingerpring Image Quality (i.e., a quality metric), and NIST corresponds to National Institute of Standards and Technology.

As discussed above, in addition to obtaining biometric identifiers, such as by scanning the user's iris or obtaining a fingerprint, a digital self-image of the user may also be obtained as part of the enrollment process. For example, FIG. 3C shows that an image 332 of the user can be captured using a camera 334. In some implementations, image 332 can be a facial image of the user (e.g., a selfie type image) or full body image of the user. As described above, extraction module 106 of system 100 can examine the captured image 332 and extract biometric information (hair color, eye color, height, etc.) about the user from the image using one or more algorithms.

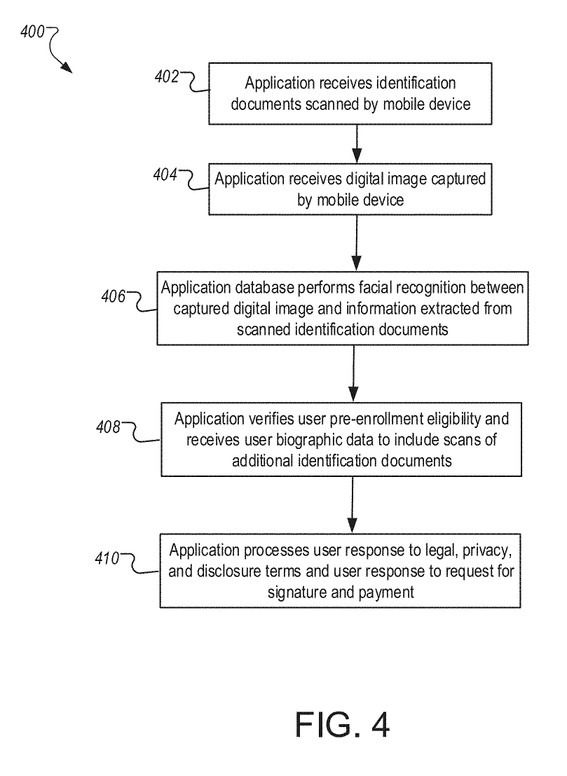

FIG. 4 illustrates an example process for acquiring user information during a pre-enrollment phase of a program. In some implementations, process 400 may be performed by system 100 and correspond to an example pre-enrollment process. Accordingly, process 400 is described with respect to system 100 and includes process steps related to a pre-enrollment phase of enrollment into an example identity verification program. In alternative embodiments, process 400 can also be performed by systems other than system 100.

In some implementations, process 400 is performed by one or more processors included in system 100 that execute instructions, e.g., instructions 114, to enroll users into an example identity verification program, or to verify information about users. The one or more processors use data, such as biometric identifiers, demographic information, digital image information and identity records, which are stored in database 112 or other related databases (not shown).

Process 400 begins at block 402 in which an application program associated with system 100 receives identification documents scanned by an example computing device such as user device 103. The computing device can be associated with an applicant that wishes to enroll in an example identity verification program. At block 404, the application receives one or more digital images captured by user device 103. At block 406 in which an application database (e.g., database lookup 107 or submission module 116) performs facial recognition between at least one captured digital image and information extracted from scanned identification documents.

Process 400 further includes block 408, in which the application verifies user pre-enrollment eligibility and receives user biographic data to include scans of additional identification documents. In some instances, the additional identification documents can include, birth certificates, affidavit documents, or other related identification documents. At block 410, the application processes one or more user responses to legal, privacy, and disclosure terms as well as processes the applicant's submitted signature and payment information.

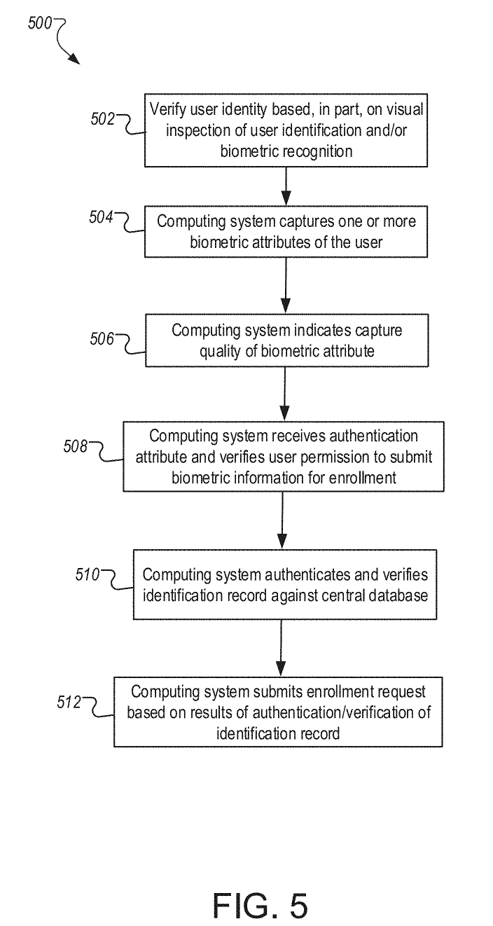

FIG. 5 illustrates an example process for acquiring user information during an on-site enrollment. In some implementations, process 500 may be performed by system 200 and correspond to an example on-site enrollment process. Accordingly, process 500 is described with respect to system 200 and includes process steps related to an on-site enrollment phase of enrollment into an example identity verification program. In alternative embodiments, process 500 can also be performed by systems other than system 200.

In some implementations, process 500 is performed, at least, by one or more processors included in computing device 202 of system 200. The one or more processors of computing device 202 execute instructions stored in a memory unit of the device to facilitate user enrollment into one or more programs, or to verify information about users. The one or more processors can also use data, such as biometric identifiers, demographic information, digital image information and identity records, which are stored in database 112 or other related databases (not shown).

Process 500 begins at block 502 in which a user identity is verified based, in part, on visual inspection of the user's identification card and/or recognition of the user's biometric attributes by performing facial scans or iris scans on the user. At block 504, an example computing system (e.g., capture device 204, 205, or 206) captures/acquires one or more biometric attributes of the user. At block 506, the example computing system indicates a capture quality of the captured/acquired biometric attribute. At block 508, a computing device, such as mobile device 202, receives an authentication attribute and verifies that the user has the requisite permission(s) to submit biometric information for enrollment into an example identity verification program.

Process 500 further includes block 510, in which a computing system, such as a back-end transaction processor, authenticates and verifies an identification record associated with the user against a central database that includes data associated with multiple individuals. At block 512, the computing system (e.g., mobile device 203 or processor 210) submits an enrollment request based on results of authentication/verification of identification record. For example, if the authentication and verification check against the central database indicates that the user's name, address and photo match existing or public identity records, then the computing system will proceed to submit the enrollment application request. In some implementations, recapture of biometric data or documents may be necessary to ensure sufficient quality for the enrollment to be processed, and recapture may be completed in-person on a mobile device, such as a company owned tablet.

The disclosed and other examples can be implemented as one or more computer program products, i.e., one or more modules of computer program instructions encoded on a computer readable medium for execution by, or to control the operation of, data processing apparatus. The implementations can include single or distributed processing of algorithms. The computer readable medium can be a machine-readable storage device, a machine-readable storage substrate, a memory device, or a combination of one or more them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A system may encompass all apparatus, devices, and machines for processing data, including by way of example a programmable processor, a computer, or multiple processors or computers. A system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed for execution on one computer or on multiple computers that are located at one site or distributed across multiple sites and interconnected by a communications network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The elements of a computer can include a processor for performing instructions and one or more memory devices for storing instructions and data.

Generally, a computer can also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data can include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this document may describe many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination.

Moreover, although features may be described above as acting in certain combinations and even initially claimed as such, one or more features from a claimed combination in some cases can be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. A computer-implemented method comprising:
receiving, by a computing device, identifying data about a user, the identifying data including a digital self-image of the user;
extracting, by the computing device, one or more biometric identifiers about the user;
verifying, by the computing device, at least one biometric identifier at least against a database that contains information about a plurality of individuals;
receiving, by the computing device, a confirmatory indicator associated with the user; and
in response to receiving the confirmatory indicator, processing a pre-enrollment request associated with the user, the pre-enrollment request being associated with an identity verification program.

2. The computer-implemented method of claim 1, further comprising:
executing, by the computing device, a facial recognition program to determine whether the digital self-image of the user matches a digital image of the user that is associated with an identification document.

3. The computer-implemented method of claim 1, wherein receiving identifying data about the user includes at least one of:
scanning, via the computing device, one or more identification documents associated with the user;
receiving, by the computing device, manually entered identity data about the user; or
capturing, by the computing device, the digital self-image of the user.

4. The computer-implemented method of claim 1, further comprising:
receiving a biometric data associated with the user, wherein receiving the biometric data includes at least one of performing a scan of an eye of the user or performing a scan of a fingerprint of the user.

5. The computer-implemented method of claim 1, wherein the confirmatory indicator includes the user's signature and provides confirmation that the user consents to one or more legal terms associated the identity verification program.

6. The computer-implemented method of claim 1, further comprising:
verifying, by the computing device, the user's eligibility to enroll in a pre-enrollment phase of the identity verification program, wherein verifying the user's eligibility includes analyzing a phone number associated with the user.

7. A system comprising:
one or more processing devices; and
one or more non-transitory machine-readable storage devices for storing instructions that are executable by the one or more processing devices to cause performance of operations comprising:
receiving, by a computing device, identifying data about a user, the identifying data including a digital self-image of the user;
extracting, by the computing device, one or more biometric identifiers about the user;
verifying, by the computing device, at least one biometric identifier at least against a database that contains information about a plurality of individuals;
receiving, by the computing device, a confirmatory indicator associated with the user; and
in response to receiving the confirmatory indicator, processing a pre-enrollment request associated with the user, the pre-enrollment request being associated with an identity verification program.

8. The system of claim 7, wherein the operations further comprise:
executing, by the computing device, a facial recognition program to determine whether the digital self-image of the user matches a digital image of the user that is associated with an identification document.

9. The system of claim 7, wherein receiving identifying data about the user includes at least one of:
scanning, via the computing device, one or more identification documents associated with the user;
receiving, by the computing device, manually entered identity data about the user; or
capturing, by the computing device, the digital self-image of the user.

10. The system of claim 7, wherein the operations further comprise:
receiving a biometric data associated with the user, wherein receiving the biometric data includes at least one of performing a scan of an eye of the user or performing a scan of a fingerprint of the user.

11. The system of claim 7, wherein the confirmatory indicator includes the user's signature and provides confirmation that the user consents to one or more legal terms associated the identity verification program.

12. The system of claim 7, wherein the operations further comprise:
verifying, by the computing device, the user's eligibility to enroll in a pre-enrollment phase of the identity verification program, wherein verifying the user's eligibility includes analyzing a phone number associated with the user.

13. A method comprising:
verifying at least one identity attribute of a user, based at least in part on a visual inspection of an identification item associated with the user;
receiving, by a computing system, identifying data about one or more users, the identifying data including at least one of a digital self-image of the user and a first biometric attribute;
indicating, by the computing system, a quality metric associated with the received identifying data for the one or more users;
receiving, by the computing system, an authentication attribute that can be used to verify that the one or more users have the requisite permission to submit an identification record associated with an enrollment request for an identity verification program;
verifying, by the computing system, the identification record against a database that contains information about a plurality of individuals; and
processing, by the computing device, an on-site enrollment request associated with the user for enrollment into the identity verification program.

14. The method of claim 13, wherein receiving identifying data about the one or more users includes receiving the identifying data and concurrently transmitting the identifying data from one or more biometric capture devices to a mobile device associated with the computing system.

15. The method of claim 13, wherein identifying data received about respective one or more users corresponds to identifying data received at an earlier time-period about the same respective one or more users.

16. The method of claim 15, wherein identifying data received about the respective one or more users corresponds to on-site enrollment data, and the identifying data received at the earlier time-period about the same respective one or more users corresponds to pre-enrollment data.

17. An electronic system, comprising:
one or more processing devices; and
one or more non-transitory machine-readable storage devices for storing instructions that are executable by the one or more processing devices to cause performance of operations comprising:
verifying at least one identity attribute of a user, based at least in part on a visual inspection of an identification item associated with the user;
receiving, by a computing system, identifying data about one or more users, the identifying data including at least one of a digital self-image of the user and a first biometric attribute;
indicating, by the computing system, a quality metric associated with the received identifying data for the one or more users;
receiving, by the computing system, an authentication attribute that can be used to verify that the one or more users have the requisite permission to submit an identification record associated with an enrollment request for an identity verification program;
verifying, by the computing system, the identification record against a database that contains information about a plurality of individuals; and
processing, by the computing device, an on-site enrollment request associated with the user for enrollment into the identity verification program.

18. The electronic system of claim 17, wherein receiving identifying data about the one or more users includes concurrently receiving the identifying data and, in response to concurrently receiving, concurrently transmitting the identifying data from one or more biometric capture devices to a mobile device associated with the computing system.

19. One or more non-transitory machine-readable storage devices for storing instructions that are executable by one or more processing devices to cause performance of operations comprising:
receiving, by a computing device, identifying data about a user, the identifying data including a digital self-image of the user;
extracting, by the computing device, one or more biometric identifiers about the user;
verifying, by the computing device, at least one biometric identifier at least against a database that contains information about a plurality of individuals;
receiving, by the computing device, a confirmatory indicator associated with the user; and
in response to receiving the confirmatory indicator, processing a pre-enrollment request associated with the user, the pre-enrollment request being associated with an identity verification program.

20. The non-transitory machine-readable storage devices of claim 19, further comprising:
executing, by the computing device, a facial recognition program to determine whether the digital self-image of the user matches a digital image of the user that is associated with an identification document.
